(19) United States
(12) Patent Application Publication
(10) Pub. No.: US 2014/0242222 A1
(43) Pub. Date: Aug. 28, 2014

(54) Frozen pizza preparation package and method

(71) Applicants: Michael Weinstein, West Bloomfield, MI (US); Robert Weinstein, Farmington Hills, MI (US)

(72) Inventors: Michael Weinstein, West Bloomfield, MI (US); Robert Weinstein, Farmington Hills, MI (US)

(21) Appl. No.: 14/073,949

(22) Filed: Nov. 7, 2013

Related U.S. Application Data
(60) Provisional application No. 61/768,603, filed on Feb. 25, 2013.

(51) Int. Cl. A21D 13/00

(52) U.S. Cl. CPC A21D 13/007
USPC 426/87; 426/383; 426/243

(57) ABSTRACT

A frozen pizza preparation package and method includes a prebaked frozen pizza, microwave-crisping sequence instructions that instruct sequential steps of heating the prebaked frozen pizza in a microwave oven followed by crisping the crust using a crisping appliance, and a unifying container incorporating the prebaked frozen pizza and the sequence instructions.

This application claims the benefit of U.S. Provisional Patent Application No. 61/768,603, filed Feb. 25, 2013.

### BACKGROUND OF THE INVENTION

1. Field of the Invention

The present invention relates generally to frozen pizzas. Particularly, the present invention relates to a frozen pizza devices and methods.

2. Description of the Prior Art

Pizza is a widely consumed food item in the United States. Annual pizza revenue for the year 2012 was about $32 billion, and ninety three percent of Americans eat at least one slice of pizza per month. There are about 70,000 pizzerias in the United States and 65% of them are independent firms. Pizza crusts range from thin to thick, and 61% of Americans prefer thin crust.

Despite the subjective nature of food preference and taste, there is general acceptance that pizza procured where the product is freshly prepared, such as at a pizzeria, and immediately consumed after baking, is especially desirable, and that next best is where the pizza is not immediately eaten after it is baked, but rather at another place, such as the consumer's home where it has been carried out by the consumer, or delivered to the consumer.

Considered less desirable than such fresh pizzas are those that are preserved by freezing, and later prepared for eating. This manner of pizza consumption may be necessitated when freshly baked pizza is not locally available or cannot be conveniently procured at the very time when pizza is desired. A number of factors contribute to making frozen pizza less desirable than fresh pizzas. As might be expected in the culinary arts, pizzas prepared and baked in an artisan manner as may occur at restaurants attentive to ingredients, preparation, and baking, are likely to be more pleasing to eat. Frozen pizzas, on the other hand, are typically manufactured in an industrial manner using automated equipment. Further, freezing imposes the need for preparation by the consumer. Considerable time is required for the consumer to prepare the pizza where the frozen pizza is to be baked, in some instances even exceeding the time to drive to a pizzeria or have a hot pizza delivered.

There are numerous available frozen pizzas that are widely sold at supermarkets and other food outlets. Examples include: “Tony's Cheese Crispy Crust Pizza” produced by the Schwan Food Company, Bloomington, Minn.; “DiGiorno For One Traditional Crust Frozen Pepperoni Pizza” distributed by Nestle USA, Northbrook Ill.; “Bellatora Ultra Thin Crust Pizza” prepared by Bernatello's Pizza, Inc., of Maple Lake, Minn.; “Trader Giotto's Pizza 4 Formaggi Handmade Four Cheese Pizza” distributed and sold exclusively by Trader Joe's, Moravia, Calif.; “Red Baron Classic Crust” Pepperoni Pizza distributed by Schwan's Consumer Brands, Inc, Bloomington, Minnisota; “Totino's Party Pizza” distributed by General Mills Sales. Inc, Minneapolis, Minn.; “Jeno's by Totino's Pizza for One” distributed by General Mills Sales. Inc, Minneapolis, Minn.; “Sabatasso”s Pizzeria Pizza Singles, Thin Crust” distributed by Schwan's Consumer Brands, Inc. Bloomington, Minn.; and “Kirkland Signature Pepperoni Pizza, Rising Crust” distributed by Costco Wholesale Corporation, Seattle, Wash.

The aforementioned frozen pizzas are provided with instructions for consumer preparation by one of two methods: baking, or microwave heating. Frozen pizza instructions typically instruct the consumer to heat a conventional oven to between 350-450 degrees Fahrenheit, and this may take from about 20-25 minutes depending upon the particular oven and the advised temperature. Once the oven is heated, the consumer is instructed to bake the pizza at full recommended heat for a time period ranging from 7 to 25 minutes. The process of baking a frozen pizza therefore takes from about 25 to 45 minutes.

To exemplify this, the aforementioned Tony's pizza instructs heating the oven to 400° F. and cooking on a rack for 12-14 minutes. Therefore, a total preparation time of over 30 minutes. The aforementioned DiGiorno pizza instructs heating the oven to 450° F. and placing the pizza directly on the center rack of the oven to bake for 17-19 minutes or until the cheese is melted. Instructions for the aforementioned Red Baron Pizza are to heat the oven to 400° F. and cook the pizza for 17-19 minutes. Similarly, Kirkland Pizza instructions are to heat oven to 425° F. and bake for 22-25 minutes or until cheese is melted and edges are golden brown, where total preparation time is likely to exceed 40 minutes.

Presently available frozen microwave pizzas can be ready for serving considerably more quickly than those instructed for baking. To illustrate this, the cooking instructions that are provided with above noted Tony's pizza instructs the consumer to microwave the pizza on high for 3.5 to 4 minutes until the center is melted. Above noted DiGiorno pizza instructs the consumer to microwave the product from 3.5-5.5 minutes according to the strength of the microwave oven: 5 minutes and 30 seconds at 600-800 watts, 4 minutes and 30 seconds at greater than 800 and up to 1100 watts, or 3 minutes and 30 seconds at greater than 1100 watts. If the cheese is not melted, the consumer is instructed to continue cooking the pizza in 30 second intervals.

While allowing a shorter preparation time compared to baking, the crust resulting from microwave heating tends to be less crisp when compared to baked pizzas, either freshly baked pizza or frozen pizzas that require baking. Rather than a chewy crust with a crisp outer layer that can result from baking, microwaved crusts tend to be soggy, spongy, doughy, and unevenly cooked. The unsatisfactory crusts of microwave pizzas are the subject of numerous innovations that attempt to improve upon them.

U.S. Pat. No. 4,283,424 issued to Bone et al. discloses frozen pizza crust suitable for microwave cooking. Bone et al. point out that: “ . . . most if not all pizza attempted to be cooked in a microwave oven have been characterized by . . . an extremely unpalatable, often soggy crust” and teach a composite crust with a first layer of cracker-type dough material with 5% or less moisture and a second baked bread dough crust having a moisture content of 20-40% where the drier layer is capable of absorbing water vapor generated in microwave cooking.

U.S. Pat. No. 6,627,242 issued to McPherson, et al. similarly points out that microwaved cereal products such as pizza crusts are generally not pleasing to the palate. McPherson et al. further state that it is difficult to generate a crisp or brown outer crust and that microwave heating is generally uneven. McPherson et al. state that it is for this reason that susceptors are often required, but even the use of susceptors can lead to uneven heating and/or uneven crisping of pizza crust. McPherson et al. teach an alternative to ordinary dough, namely a pizza crust comprising mesophase-gel, which when baked in a microwave oven rises in a manner similar to conventional baked-oven pizza crust. The resulting crust is described as having a firm texture and being palatable.

U.S. Pat. No. 5,519,195 issued to Keefer, et al. discloses the employment of susceptors, which are devices that incorporate material that absorbs microwave energy to become heated, to improve upon microwave cooking. The disclosure, however, points to disadvantages of heating a susceptor to high temperature to attempt to heat a food surface: risk of overheating, of breakdown of the material of the susceptor and even generation of toxic products, and teaches preventive modifications.

U.S. Pat. No. 6,204,492 issued to Zeng et al. discloses that food cooked in a microwave oven generally does not exhibit the texture, browning, or crispness that are acquired when food is cooked in a conventional oven. Zeng et al. also point to using a susceptor material that is a thin metallized film that heats with microwave focusing heat on the food. The disclosure again points to hot and cold spots, potential for fire, and arcing with these devices that their invention seeks to overcome with the placement and pattern of metallic segments.

Despite such attempts to improve upon preparation of frozen pizza using a microwave oven, the present state of the art may best be reflected in the instructions provided with presently sold microwave pizzas recommending baking rather than microwave heating for best results or to achieve a crisp crust. “Tony's Pizza for One” recommends: “Microwave on high 2 minutes 30 seconds to 3 minutes 15 seconds . . . ” and “Oven instructions: (recommended for best results) pre-heat oven to 425° F. . . . ” Similarly, “Microwavable Tony's Crispy Crust Pepperoni Pizza” includes microwave instructions, but adds: “Oven Instructions for a Crisp Crust.” Kroger brand “Classic Crispy Crust 3 Minute Microwave Pizza” has instructions to microwave the pizza and conventional oven directions that state: “for a crisp crust, bake pizza directly on oven rack.” “Sabatasso's Pizzeria Singles Thin Crust” comes with microwave instructions and also conventional oven instructions that are: “Recommended for a crisper crust.”

The strength and distribution of microwave energy is known to vary from oven to oven, and it is acknowledged that microwave cooking is spacially uneven and that heat application may vary in accordance with placement of a foodstuff in the microwave. Non-uniform heating of frozen pizza allowing pathogen persistence has been associated with food-borne illness.

What is therefore needed is a frozen pizza that can be more quickly prepared by the consumer than present frozen pizzas instructed for baking, and that has a crust that is more akin to baked pizza, and preferably pizzeria-type baked pizza than to the crust of present frozen microwave pizzas.

### SUMMARY OF THE INVENTION

Present cooking methods for frozen pizza are not entirely satisfactory and each method, i.e. baking or microwaving, has at least one significant shortcoming. Baking a frozen pizza is time consuming. Individuals may not wish to wait for the time required to bake a frozen pizza to satisfy a craving for pizza, or in some instances, may not have enough time to bake a frozen pizza. It is unwise, however, for a consumer to shortcut recommended preparation instructions, as cooking instructions provided with packaged frozen pizzas by their various manufacturers, packagers, and distributors relate to the state of preparation of the pizza before it is frozen. Present frozen pizzas often contain components that are not sufficiently cooked for consumption before the pizza has been frozen. Care to follow instructions is especially important to avoid food-borne illness when the frozen pizza contains a meat topping.

The drawback of frozen pizzas that consumers reheat by microwave is that the crusts lack the texture and crispness of baked pizzas. The alternative cooking methods described above also have shortcomings. The provision of a portion of crust with a cracker layer to imitate the crispness of ordinary baked pizza cannot be expected to result in a crust having the same texture and crispness of conventional baked pizza, especially a pizzeria-type pizza, but rather to result in a cracker-like imitation. The use of chemical additives to emulate natural foods is undesirable.

The present invention solves these problems by providing a frozen pizza preparation package and method that allows for rapid preparation of frozen pizza compared to baking and achieves a more crisp pizza crust compared to microwave pizzas that are presently available to an ordinary consumer, that is, one who is not expert in the art of pizza preparation or pizza baking.

It is an object of the present invention to provide a frozen pizza that can be quickly prepared by a consumer, preferably in less than five minutes to quickly satisfy a craving for pizza, and that has a crisp crust after preparation.

It is another objective to enable a consumer to quickly prepare a pizza that is more closely akin to a pizzeria-type pizza than has been heretofore possible.

It is a further object of the present invention to provide a consumer with a frozen pizza preparation package and teach a method that allows a consumer convenient and rapid preparation of such a pizza.

It is yet another object of the present invention to provide a consumer with a pizza with a baked crust that has then been frozen and instructions that allow the consumer to approximate or reestablish the texture and crispness of the crust before it was frozen.

It is another object of the present invention to provide a consumer with a prebaked pizza that is then frozen and instructions that allow the consumer to approximate or reestablish the taste, texture, and crust crispness of the very pizza before it was frozen, preferably where the pizza is a pizzeria-type pizza, and most preferably where the pizza is a handmade pizzeria-type pizza.

Another object of the present invention is to provide a consumer with a prebaked, and then frozen pizza, and with instructions that enable the consumer to improve upon its pre-frozen culinary qualities by virtue of being crisped twice.

The present invention achieves these and other objectives by providing a pizza rapid preparation package. The pizza rapid preparation package includes a pizza that has been prebaked, and then frozen, and instructions for such pizza to be quickly reheated and then crisped by the consumer.

The term “fresh pizza” means a pizza that has not been frozen.

The term “pizzeria-type pizza” means a pizza that is made and sold at pizzerias and consumed hot from the oven or delivered, having a crisp crust that is either thin or thick, but preferably thin.

The term “handmade pizzeria-type pizza” means a pizza made with attention to preparation and preferably baked directly on a heated stone in a pizza oven as is known in the art.

The term “topping or toppings” means any of sauces (for example, tomato sauce), cheeses (examples being mozzerella and parmesan), meats (examples being pepperoni, bacon, hamburger, and sausage), vegetables (examples being onions, mushrooms, and peppers), and other food ingredients, alone or in combination that are known in the art to be layered onto pizza crust.

The term “prebaked” means a pizza having a crust and toppings such that the pizza is suitable to eat prior to its being frozen.

The term “prebaked frozen pizza” is herein used to refer to a prebaked pizza that is then frozen.

The terms “thin crust pizza” and “thick crust pizza” has those meanings as ordinarily understood by consumers of pizza and by one of ordinary skill in the art of pizza making.

In one embodiment of the present invention, the frozen pizza preparation package includes a prebaked frozen pizza, and microwave-crisping sequence instructions. The microwave-crisping sequence instructions include a heating step employing a microwave oven, followed by a crisping step in a crisping appliance. One example of a crisping appliance includes, but is not limited to, a stovetop skillet or pan to crisp the crust of the microwave-heated pizza on a stovetop.

In preferred embodiments, the package contains means to safely transfer the pizza between heating and crisping devices to avoid touching heated surfaces. In its most preferred embodiment, the pizza will have been a handmade pizzeria-type pizza, made and baked using artisan methods prior to freezing.

In another embodiment of the present invention, the frozen pizza preparation package includes a prebaked frozen pizza, a transfer substrate, and microwave-crisping sequence instructions. The microwave-crisping sequence instructions prescribes a heating step employing a microwave oven followed by a crisping step, and the employment of the transfer substrate to move the pizza from the microwave oven to the crisping appliance.

In working with samples of prebaked pizza that were frozen just after baking, it was found that a microwave step must be included in the preparation process in order to accomplish the very quick preparation that is intended by the present invention. No other method tried suffices to quickly thaw and sufficiently heat the pizza. It was found that heating an approximately 80 grams of frozen pepperoni pizza in a 1000 watt output microwave oven for less than one minute (i.e. about 40 seconds) sufficiently reheated frozen toppings of tomato sauce and pepperoni, and melted frozen cheese topping. The same was found for heating approximately 200-300 grams of the same frozen pizza for about two minutes using the same oven. It was further found that no other ordinary cooking method was sufficient to thaw and heat frozen pizza in such rapid manner. In comparison, it has been found that other means such as conventional home oven baking requires a great deal more time; approximately 15 minutes to heat an oven to 350-450° F. and 12-15 minutes to sufficiently thaw and heat up this small amount of frozen pizza.

In experimenting with stovetop preparation, it was found that it takes at least 8-10 minutes to thaw and reheat the frozen cheese and pepperoni toppings on about 80 grams of prebaked frozen pizza in a stovetop skillet, even if the skillet is covered. When the pizza is placed directly on the skillet to achieve maximal heat, it was found that it was more likely than not for the bottom of the crust to burn before the toppings are sufficiently heated. Turning the pizza topping side down to more quickly heat that surface provided a result that is messy and unacceptable. Attempts were made to try and improve upon this by varying the stovetop cooking conditions, such as raising the pizza away from the pan bottom or adjusting the heat, but have found that either the bottom burns before the toppings melt and heat to a sufficient temperature or it takes excessively long to melt and heat the toppings (layers of tomato sauce, cheese, and pepperoni).

The prebaked frozen pizza of these experiments is a thin crust pizza that was made with somewhat moist dough and baked directly on a brick pizza oven floor before freezing. In some preparations, a coal fire was employed. It was found that microwaving approximately 80 grams of frozen pepperoni pizza in a 1000 watt output microwave oven for about 40 seconds sufficiently heated frozen toppings of tomato sauce and pepperoni, and melted frozen cheese topping. The same was found for heating approximately 200-300 grams of the same frozen pizza for about two minutes using the same oven. It is anticipated that lager pizzas having a thick crust, yet sized to fit into a microwave oven, and/or the use of a less powerful microwave oven, would require proportionally more time, but not exceeding about 7 minutes. We have found no other ordinary cooking method sufficient to thaw and heat a_frozen pizza in such rapid manner.

The crust that resulted after microwave heating, however, was best characterized as soggy, and clearly not as crisp as it was before it was frozen. Lifting the edges of the pizza after it was reheated in the microwave caused the pizza to sag. Further, neither the crust nor toppings were as evenly reheated as might be desired.

To improve upon this, supplemental means to evenly reheat the pizza and to crisp the crust were sought. Heating on an open stovetop pan at high heat was now found to be effective, reproducibly resulting in more even cooking of the pizza and in achieving sought-after crust crispiness. Moreover, a surprisingly short period of open skillet heating was found to produce the desired outcome: about 30-90 seconds for a thin crust pizza weighing from about 75-300 grams. It is anticipated that crisping larger pizzas having a thick crust, or crisping at lower heat might require more time, but not more than about 3 minutes.

It was expected that subjecting a reheated frozen pizza to high direct skillet heat would cause the crust to burn as quickly as might occur when ordinarily baking fresh pizza, and that there was little leeway between crisping the crust and burning it. In contrast to expectation, stovetop heating at high heat could be surprisingly continued for a period past when the crust was sufficiently crisped without the crust burning. It is hypothesized that the vaporization of water in the crust during the preceding microwave step, while producing undesirable sogginess, also serves a protective function and prevents the crust from burning during the subsequent step of pan crisping. Regardless of the reason, the unexpected latitude for crisping a microwave-reheated, prebaked frozen pizza on a stovetop pan or skillet without burning it, even though the crust had been previously baked, suggested a reliable preparation method for lay individuals and commercial viability. That is, it was demonstrated that a frozen pizza that could be reliably and rapidly prepared to be both hot and crispy could be made available to a consumer by providing a pizza that is prebaked prior to its being frozen, therefore requiring reheating and little, if any, time-consuming cooking, providing a pizza size that is commensurate with ordinary microwave ovens and cooktop pans, and providing instructions teaching a rapid microwave reheating-crisping sequence to prepare the frozen pizza.

Despite the subjective nature of food preference, tasters have uniformly regarded the pizzas resulting from the described frozen pizza rapid preparation method of the present invention as preferable in taste, texture, and crust crispness when compared to samples of present microwave heated pizzas prepared according to their microwave instructions that often provide soggy, bready, rubbery, and/or doughy crusts, or come out unevenly heated. Moreover, using the combined method of microwave heating and stovetop crisping of the present invention, it was found that it was possible to approximate the taste, texture, and especially crispness of the crust of a pizzeria-type prebaked fresh pizza before it was frozen.

In some instances, observers have voiced a preference for the prebaked frozen pizza after it was prepared according to the disclosed methods over the same fresh baked pizza. This was an unexpected outcome. Prebaking a pizza, freezing it, then reheating the pizza in a microwave where moisture in the toppings and crust is mobilized, and finally re-crisping the pizza on a stovetop pan may produce a set of conditions that allows the flavor of the topping(s) to seep into the crust.

In preferred embodiments, the package contains means to safely transfer the pizza between heating and crisping devices to avoid touching heated surfaces. In its most preferred embodiment, the pizza will have been made and baked using artisan methods prior to freezing.

To simplify transfer of hot pizza between two heating modalities, an optional transfer device such as a planar transfer substrate was devised to avoid the potential for touching hot pizza or another hot surface.

Hence, in another embodiment of the present invention, the frozen pizza preparation package includes a prebaked frozen pizza, a transfer substrate, and microwave-crisping sequence instructions. The microwave-crisping sequence instructions prescribes a heating step employing a microwave oven followed by a crisping step, and the employment of the transfer substrate to remove the pizza from the microwave oven to the crisping appliance.

The transfer substrate is preferably configured so it can be situated under the pizza before and during the microwave-heating step, and such that it can be used to convey the just-heated pizza from the microwave to a crisping device that is a stovetop skillet, or alternatively, a toaster oven without touching a hot surface. The crisping device has preferably been heated prior to its being needed, most conveniently when the pizza is being heated in the microwave. When the crisping step is finished, the pizza can be transferred back to the transfer substrate from which the pizza can be eaten. The pizza can instead be served on an ordinary plate. In the case of using a skillet, the pizza can be slid from the skillet onto the plate. When using a toaster oven the pizza can be transferred to a plate using the transfer substrate. Where there may have been concern about difficulty or inconvenience with a two-staged pizza preparation method, it has been found that the sequence of microwave heating and crisping is uncomplicated, can be facilitated by a transfer substrate, and that the method is desirable in providing the immediate reward of a heated pizza with a crispy crust within a very few minutes.

It is contemplated that the transfer substrate need not be elaborate in design. It is preferably constructed of microwave-compatible material to allow the transfer substrate to be microwaved with the pizza and situated for removing the pizza from the microwave oven and for positioning the pizza into the crisping device. Suitable materials that might be employed for the transfer substrate include paper or plastic or a combination of these. The incorporation of susceptor foils, while appearing unnecessary, is not precluded. Various grasping means by which the transfer apparatus can be securely grasped by a consumer to transfer the pizza without touching a hot surface are also contemplated. Alternative transfer substrate configurations that would allow the consumer to transfer the pizza without touching a hot surface are considered within the scope of the invention.

In a further embodiment of the present invention, the transfer substrate has a grasping adaption selected from the group consisting of at least one tab extending co-planar from a peripheral edge, a handle extending above the transfer substrate, an elongated tab pivotally connected adjacent a peripheral edge of the transfer substrate where the elongated tab pivots between a stored position and a grasping position, and a transverse side extending from the peripheral edge of the transfer substrate.

In still another embodiment of the present invention, the transfer substrate incorporates a material selected from the group consisting of plastic, paper, foil-coated paper, cardboard, and combinations thereof.

In yet another embodiment of the present invention, the frozen pizza package includes a container that unifies the pizza, the transfer substrate, and the instructions.

In another embodiment of the present invention, there is disclosed a method that involves a microwaving a prebaked frozen pizza for a predefined time, transferring the microwaved pizza to a device for crisping the crust of the pizza, and crisping the crust of the pizza. The crisping step may be performed using a stovetop pan/skillet on a stovetop, or a toaster over.

### BRIEF DESCRIPTION OF THE DRAWINGS

FIG. 1 is a perspective view of one embodiment of the present invention showing a frozen pizza preparation package.

FIG. 2 is a perspective view of one embodiment of the frozen pizza of FIG. 1.

FIG. 2A is a cross-sectional view of the frozen pizza with topping showing the peripheral crust edge.

FIG. 3 is a perspective view of the present invention showing one embodiment of the transfer substrate with at least one tab extending from the periphery of the transfer substrate as the grasping adaptation.

FIG. 4 is a perspective view of the present invention showing another embodiment of the transfer substrate with a handle extending from the periphery of the transfer substrate above and across the transfer substrate.

FIG. 5 is a perspective view of the present invention showing another embodiment of the transfer substrate with a pivotable, elongated tab pivotally connected adjacent the periphery of the transfer substrate as the grasping adaptation.

FIG. 6 is a top view of the transfer substrate in FIG. 5 showing the elongate tab in a stored position.

FIG. 7 is a top view of the transfer substrate in FIG. 5 showing the elongate tab in a grasping position.

FIG. 8 is a perspective view of another embodiment of the transfer substrate showing transverse sides and an open side.

FIG. 9 is a perspective view of one embodiment of the container of the present invention showing the instructions on a top surface.

FIG. 10 is a schematic illustration of a preparation step of the present invention showing the prebaked frozen pizza ready for being placed in a microwave oven.

FIG. 11 is a schematic illustration of a step of the present invention showing the microwaved pizza being transferred utilizing a transfer substrate to a stovetop pan for crisping.

FIG. 12 is schematic illustration of a step of the present invention showing the crisped pizza being placed back onto the transfer substrate.

FIG. 13 is a schematic illustration of a preparation step of the present invention showing the prebaked frozen pizza being placed in a microwave oven.

FIG. 14 is a schematic illustration of a step of the present invention showing the microwaved pizza being transferred utilizing a transfer substrate to a toaster over for crisping.

### DETAILED DESCRIPTION OF THE PREFERRED EMBODIMENT

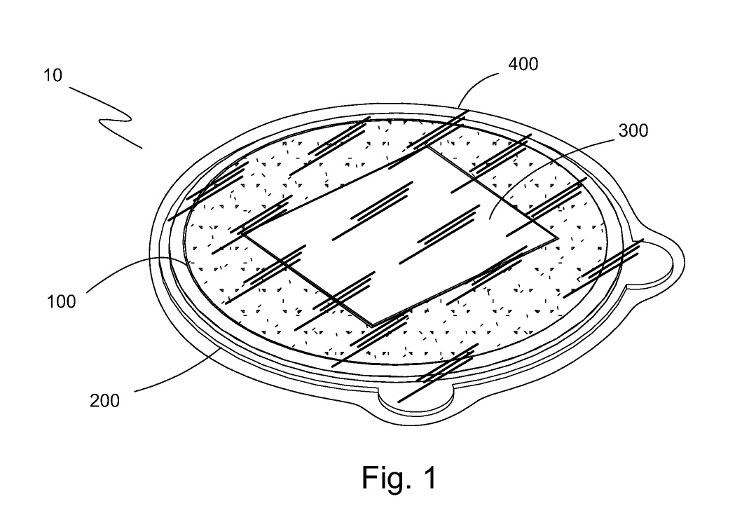

The preferred embodiments of the present invention are illustrated in FIGS. 1-14. FIG. 1 shows one embodiment of a frozen pizza preparation package 10 of the present invention. Frozen pizza preparation package 10 includes a prebaked frozen pizza 100, a transfer substrate 200, microwave-crisping sequence instructions 300, and a unifying container or wrap 400. Package 10 preferably has a surface upon which the sequence instructions 300 are displayed. It is contemplated that sequence instructions can alternatively be unified in the package, for example, on a separate sheet within the package.

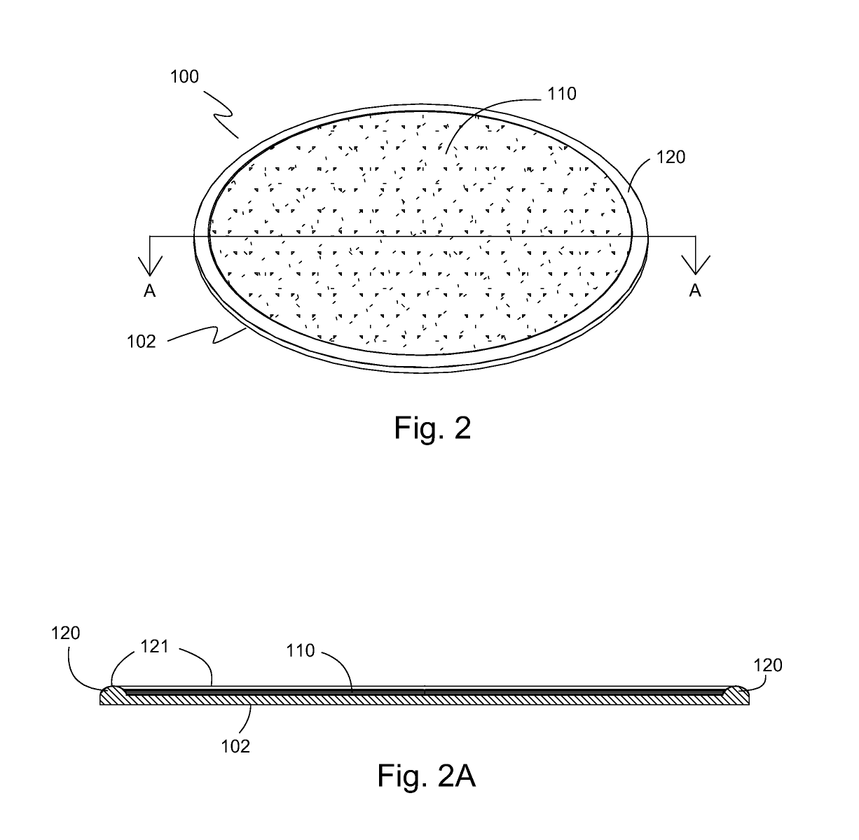

Turning now to FIGS. 2 and 2A, frozen pizza 100 includes a pizza body 102 made of dough known in the art as pizza dough, at least one topping 110 disposed over a major portion of the pizza body 102 and a peripheral crust border 120. As more clearly shown in FIG. 2A, peripheral crust border 120 preferably has a peripheral crust top 121 that is approximately ⅛″ or greater such that the toppings do not run over the crust during heating. Pizza body 102 typically has a disc shape but may also be square, rectangular, or other shape, or irregular, and is not limited to a circular shape. The pizza may be of any size, but preferred sizes are portions that are suitable for one or two individual servings and that might easily fit into an ordinary microwave oven or skillet, therefore about 6″ to 14″ in largest dimension. Thin crust pizzas of such dimension weigh about 100 to 500 grams and most optimally about 160 to 320 grams. It is further considered that a mini-pizza as small as 50 grams might be an alternative.

Frozen pizza 100 is a prebaked pizza. This is predicated on a number of reasons. Prebaking the pizza before freezing allows the manufacturer to control how the product is prepared and baked before it is frozen. There is a range of expertise and consequently of pizza quality among pizza makers. Particular manufacturers may want their product to have characteristics that can only result from their selected techniques, ingredients, ovens, baking fuels (for example wood or coal), or proprietary skills. Prebaked pizza provides the quickest path from freezer to plate, where the intent of the present invention is to provide a quickly prepared frozen pizza, and not require time to bake an unbaked pizza.

A further rationale for the prebaked pizza of the present invention relates to preparation of the toppings, since it is unlikely to crisp pizza toppings by microwave heating, or stovetop heating. Crispness of toppings when desired, for example, pepperoni, is best accomplished by baking.

Another advantage of providing a consumer with a prebaked frozen pizza of the present invention is that this lessens the likelihood of transmitting food-borne pathogens as there is valid concern for pathogen transmission particularly with employing a microwave to heat previously uncooked frozen pizza in that some areas of the pizza might remain undercooked.

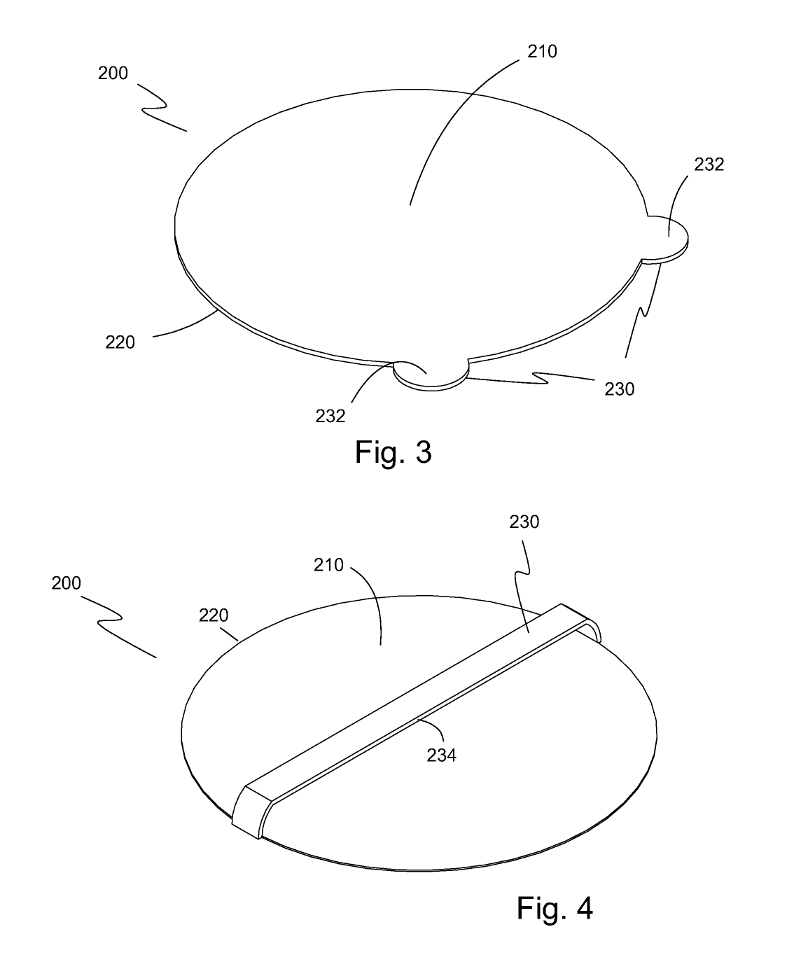

Turning now to FIG. 3, there is illustrated one embodiment of the transfer substrate 200 of various embodiments of the present invention. Transfer substrate 200 has a substrate body 210, a rounded peripheral edge 220, and a grasping adaptation 230. Substrate body 210 supports frozen pizza 100 during the microwaving process. In this embodiment, grasping adaptation 230 is one or more tabs 232 that extend away from peripheral edge 200 and co-planar with substrate body 210. Tab 232 allows a consumer to grasp transfer substrate 200 in an area that would not cause the consumer's hand to be in direct contact with the hot pizza after it is heated in the microwave oven. The rounded peripheral edge 220 of this embodiment is illustrated to conform to the shape of a rounded pizza, and in this case, also conform to the shape of a rounded stovetop pan. It is preferred for the transfer-edge of transfer substrates of the present invention to be in essentially the same two dimensional plane as the pizza when it sits upon the transfer substrate, as to allow the pizza to be easily slid from the transfer substrate onto a stovetop pan or placed in or out of a toaster oven.

FIG. 4 exemplifies another embodiment of the transfer substrate 200 of the present invention. In this embodiment transfer substrate 200 has a substrate body 210, a rounded peripheral edge 220 and a superiorly situated grasping adaptation 230. In this embodiment, grasping adaptation 230 is in the form of a handle 234 that is situated above substrate body 210 where a frozen pizza 100 would be supported. Handle 234 is connected to the peripheral edge 220 of transfer substrate 200, yet there is an adequate transfer-edge 220 for a just-microwaved pizza to be slid off the transfer substrate to a crisping device.

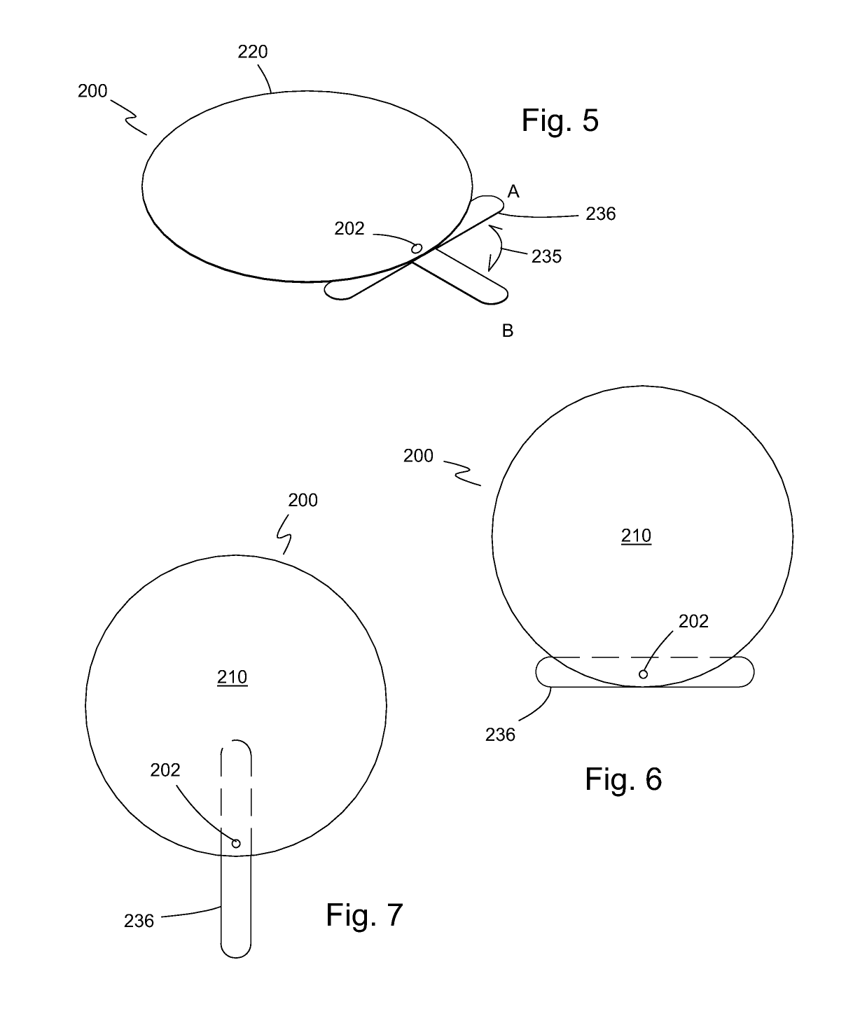

FIGS. 5, 6 and 7 illustrate yet another embodiment of transfer substrate 200. In this embodiment transfer substrate 200 has a substrate body 210, a rounded peripheral transfer edge 220 and a pivotally-connected grasping adaptation 230. As seen in FIG. 5, pivotally-connected grasping adaptation 230 is in the form of an elongated tab 236 that is pivotally connected to substrate body 210 adjacent peripheral edge 220 at pivot 202. Elongated tab 236 pivots from a stored position A to a grasping position B as indicated by arrow 235. Although elongated tab 236 is illustrated as being pivotally connected to substrate body 210 at approximately the center of elongated tab 236, it is contemplated that the pivot point of elongated tab 236 may be in any position longitudinally along elongated tab 236. FIG. 6 illustrates elongated tab 236 in stored position A where elongated tab 236 can be mostly on the underside of the transfer substrate 200 during microwaving and pivoted for grasping by the consumer to transfer the pizza. FIG. 7 illustrates elongated tab 236 in grasping position B. In grasping position B, elongated tab 236 serves as a handle for the consumer to grab when transferring the frozen pizza 100 from unifying container or wrap 400 into the microwave oven and from the microwave oven to a crisping device.

In the alternative, elongated tab 236 may be configured on the underside of a transfer substrate 200 to retract or extend on a track or support flanges (not shown).

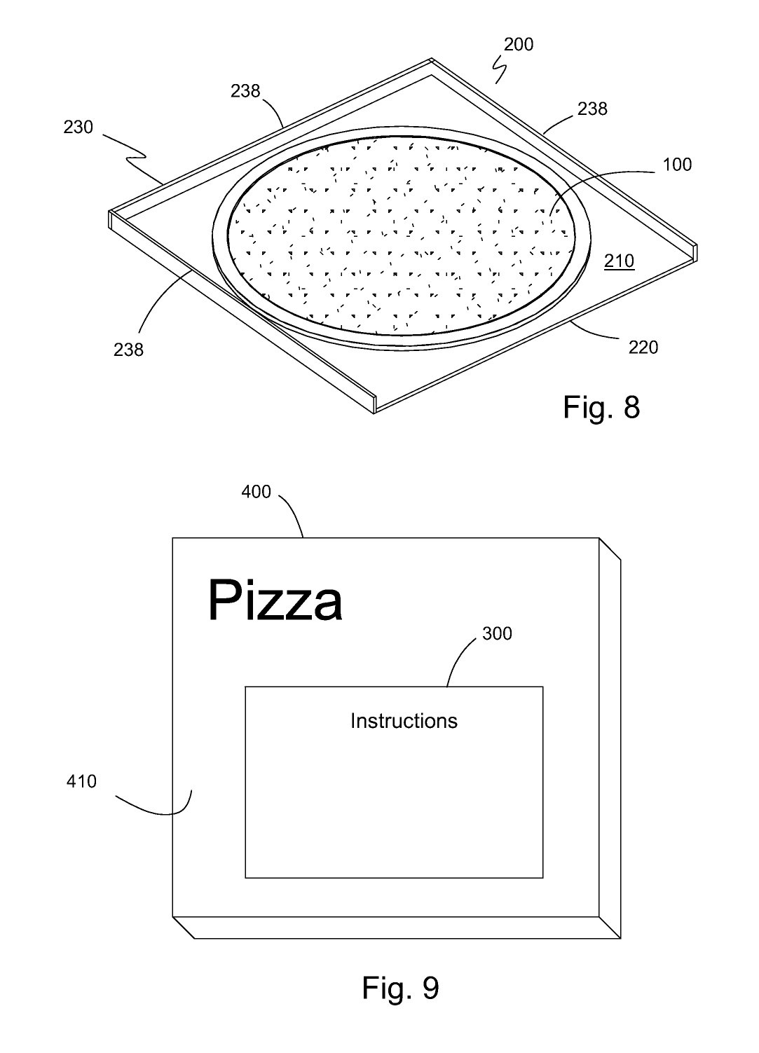

Turning now to FIG. 8, there is illustrated another embodiment of transfer substrate 200. In this embodiment, transfer substrate 200 is shown supporting frozen pizza 100 where the shape of transfer substrate 200 is square. Grasping adaption 230 is in the form of transverse sides 238 extending from peripheral edge 220 of substrate body 210. Transverse sides 238 extend upwardly from three of the four peripheral edges 220 of substrate body 210. The open edge results in a surface in essentially the same plane as the illustrated pizza, where the transfer edge would not contain the pizza, but rather allow the pizza to be readily slid from the transfer substrate 200 to a crisping appliance such as a stovetop pan or toaster oven. It is contemplated that additional sides or portions of sides might be alternatively configured to enlarge a transfer edge if desired. The present invention anticipates other transfer substrate adaptations to transfer hot pizza between heating modalities, such as grasping, tong, or pincer-like configurations to grasp the pizza, as being within the scope of the present invention.

FIG. 9 illustrates another embodiment of container 400. Container 400 has a surface 410 that contains microwave-crisping sequence instructions 300. For example, container 400 may be a conventional pizza box. The microwave-crisping sequence instructions describe the steps for sequentially microwave heating frozen pizza 100 in a microwave oven and then crisping the microwaved pizza in either a stovetop pan or in a toaster oven. It is noted that a prebaked frozen pizza and instructions containing the sequential microwave heating step and crisping step for a consumer to prepare the frozen pizza prior to eating are critical features of the present invention. Container 400 serves to unify instructions 300 with frozen pizza 100 and, when incorporated, transfer substrate 200.

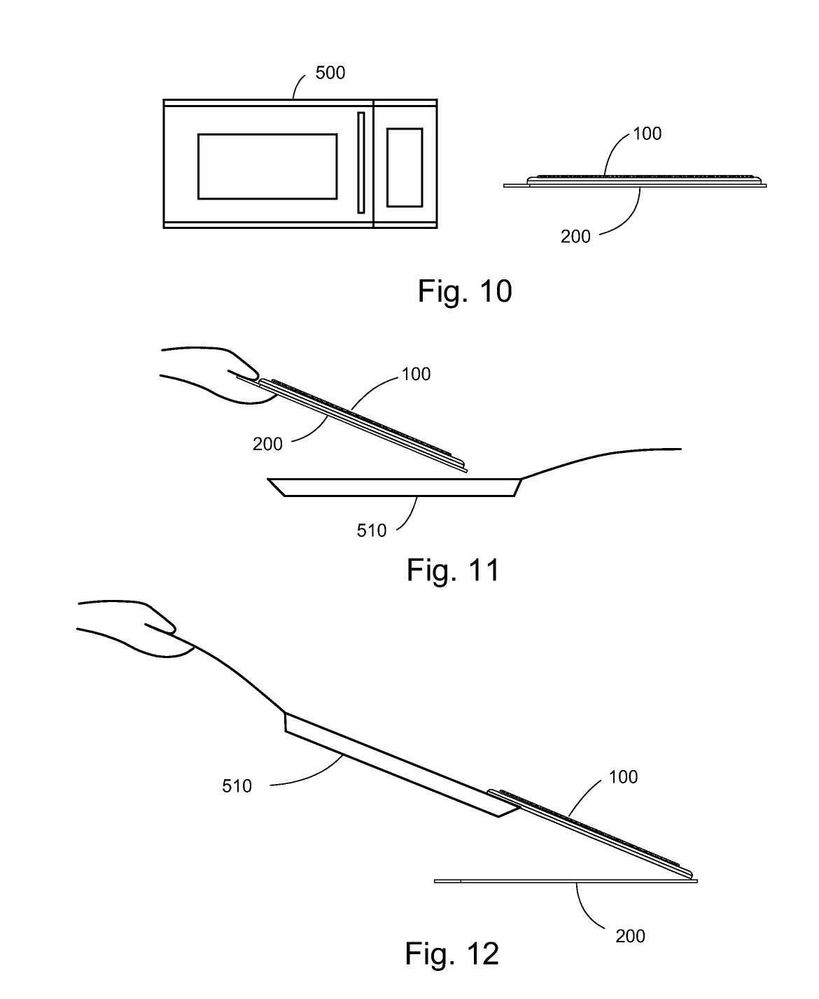

FIGS. 10, 11 and 12 schematically exemplifies instructions of preferred embodiments of the present invention, which are preferably both illustrated and written. FIG. 10 illustrates a step of using a microwave oven 500 to cook prebaked, frozen pizza 100 (side view) that is supported by transfer apparatus 200. Although not shown, it is understood that a consumer places prebaked, frozen pizza 100 and transfer substrate 200 into microwave oven 500 for cooking/heating for a predefined time period. FIG. 11 illustrates a second step of sliding the microwave-heated pizza 100 onto a stovetop pan 510 using transfer substrate 200. It is understood that stovetop pan 510 is heated on a stovetop to perform the crisping step. FIG. 12 illustrates sliding the crisped pizza 100 from the stovetop pan 510 back onto the transfer substrate 200 from which it can be eaten, or the pizza 100 might be slid from the pan 510 onto an ordinary plate, as preferred.

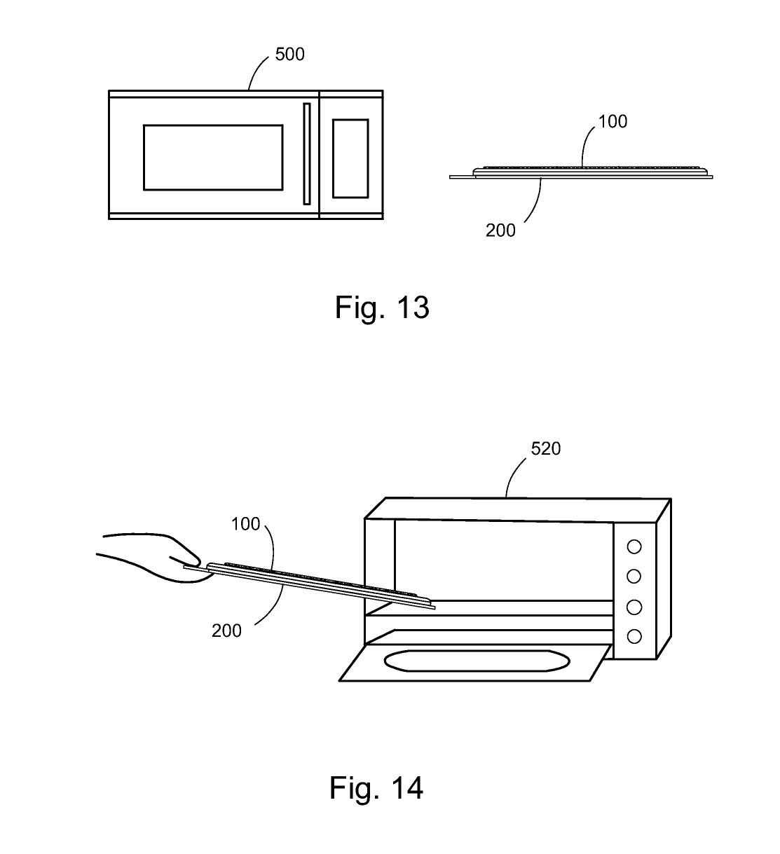

FIGS. 13 and 14 schematically exemplify instructions for toaster-oven crisping as an alternative to stovetop crisping. FIG. 13 illustrates a step of using a microwave oven 500 to heat a prebaked frozen pizza 100 that is sitting upon a transfer substrate 200. As previously described, it is understood that a consumer places prebaked frozen pizza 100 and transfer substrate 200 into microwave oven 500 for cooking/heating for a predefined time period. FIG. 14 illustrates a second step of sliding the microwave-heated pizza 100 into a toaster oven 520 using the transfer substrate 200. It is preferred that the oven be sufficiently heated so as to be ready to accept the pizza when the microwave step is completed. It is found that this might require more time compared to stovetop crisping where the skillet can be heated more quickly. The time to heat either a stovetop pan 510 or a toaster oven 520 is contemplated to vary with the kitchen appliances employed, but in either case, it is less than the time required to heat a residential kitchen oven to baking temperature. Eight (8) ounce samples of microwave-reheated prebaked frozen pizza 100 were adequately crisped in a toaster oven at temperatures of 400° F. for one to two minutes. The pizza crusts produced with toaster-oven crisping were found to be somewhat drier than with pizzas subjected to stovetop crisping. It is contemplated for instructions of embodiments of the present invention to instruct stovetop crisping step and/or toaster-oven crisping. When using a toaster oven 520 rather than a stovetop pan 510 for crisping, the transfer edge of transfer substrate 200 is preferably structured to allow the transfer substrate 200 to be slid under the pizza 100 to remove it from the toaster oven 520.

Adaptations to avoid sticking of the pizza 100 to various surfaces such as the transfer substrate 200 are also considered. It is contemplated that a pizza 100 of the present invention that is fashioned with crust alone at its outermost periphery is preferable to one that has toppings at its periphery that might melt onto the transfer substrate 200 when the pizza 100 is microwaved. In such a case, it is contemplated that the melting of the toppings onto transfer substrate 200 will cause the pizza 100 to be more difficult to slide from the transfer substrate 200 onto the stovetop pan 510 or toaster oven 520. It is further considered that adding a layer of corn meal, semolina, or other non-stick material, as may be employed in pizzeria baking, to the pizza 100 of the present invention before it is frozen, might be optionally helpful to facilitate sliding the pizza 100 from the transfer substrate 200 or other surfaces. With regard to stovetop crisping, it has been observed that the microwave reheated, prebaked pizza 100 does not stick to a conventional non-stick pan when the pizza 100 was crisped at full heat for a short period of time (under two minutes), and that it was concluded not necessary to prepare the pan with oil or other entity to prevent sticking in this instance. Lastly, it has been conjectured that outcomes with the prebaked pizza 100 frozen in aluminum foil wrapping appear superior to the same when frozen in a plastic wrapping, an optional consideration.

It is contemplated that the elements of preferred embodiments of the present invention: a prebaked frozen pizza 100; a transfer substrate 200; microwave-crisping sequence instructions 300 that instruct a microwave heating step and a crisping step, are incorporated together with a unifying container 400 where the container has a surface 410 that displays instructions for sequential microwave heating followed by crisping of the prebaked frozen pizza 100. Preferred embodiments of the present invention include a transfer substrate 200; and include instructions that instruct utilizing the transfer substrate 200 to transfer heated pizza from the microwave oven to a crisping device.

It is further recognized that preferred pizzas intended by the present invention, and the means to produce them that necessitate artisan baking are contrary to the present prevailing convention of frozen pizzas prepared by automation. Artisan baking refers to the role of the individual and not industrial values of scale. It is a further preferred that this be reflected on the packaging of the product, by making the distinction between artisan-baked pizza that is baked in a traditional manner and pizza that is produced in an automated fashion. Further, packaging distinctions such as indicating the pizza being cooked on a heated stone and/or with a wood or coal fire are also considered desirable.

The present invention also recognizes that the production of a hand-made frozen pizza necessitates the employment of experienced pizza bakers and, in essence, comprises a method of improving food quality and encouraging employment of individuals to that purpose.

The present invention teaches devices and methods to allow a consumer to procure a frozen pizza package that can be quickly prepared to achieve a better quality of pizza than with present frozen pizzas, and especially present quickly prepared frozen pizzas.

The present invention also teaches means and methods for a pizza maker or pizzeria to provide a consumer that is either outside of shopping range, or who would find shopping at the pizza production site inconvenient, with a pizza that approximates their product.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A frozen pizza rapid preparation package comprising:
a prebaked frozen pizza having a crust and at least one topping;
microwave-crisping sequence instructions that instruct sequential steps of heating the prebaked frozen pizza in a microwave oven followed by crisping the crust using a crisping appliance; and
a unifying container incorporating the prebaked frozen pizza and the microwave-crisping sequence instructions.

2. The package of claim 1 wherein the prebaked frozen pizza is a thin crust pizza.

3. The package of claim 1 wherein the prebaked frozen pizza has a characteristic selected from the group consisting of a weight in the range of about 50 to 500 grams, a weight in the range of about 160 to about 320 grams, a largest dimension that measures in the range of about 6 to about 14 inches, and a crust periphery without toppings that is about ⅛ inches or greater.

4. The package of claim 1 wherein the instructed time for microwave heating is selected from the group consisting of a range of about 40 seconds to about 7 minutes and a range of about 1.5 to 3 minutes.

5. The package of claim 1 wherein the crisping appliance is selected from the group consisting of a stovetop pan on a stovetop and a toaster oven.

6. The package of claim 5 wherein the instructed time for stovetop crisping is selected from the group consisting of a range of about 30 seconds to about 3 minutes and a range of about 30 seconds to about 90 seconds.

7. The package of claim 1 further comprising a transfer device selected from the group consisting of a planar transfer substrate and a pizza pincer adaptation wherein the microwave-crisping instructions includes instructing the use of the transfer device to transfer the microwave heated pizza from the microwave oven to the crisping appliance.

8. The package of claim 7 wherein the planar transfer substrate incorporates a grasping adaptation selected from the group consisting of at least one tab extending co-planar from a peripheral edge, a handle extending above the transfer substrate, an elongated tab pivotally connected adjacent a peripheral edge of the transfer substrate where the elongated tab pivots between a stored position and a grasping position, and a transverse side extending from a portion of the peripheral edge of the planar transfer substrate.

9. The package of claim 7 wherein the planar transfer substrate incorporates a material selected from the group consisting of plastic, paper, foil-coated paper, and combinations thereof.

10. The package of claim 1 wherein the prebaked frozen pizza is a handmade pizzeria-type pizza.

11. The package of claim 1 wherein the container has a surface that contains the instructions.

12. A method of making a frozen pizza preparation package usable by a consumer, the method comprising:
making a pizza having a crust and at least one topping thereon;
baking the pizza for a sufficient time wherein the pizza is suitable to eat;
freezing the pizza;
devising microwave-crisping sequence instructions that instruct sequential steps of heating the frozen pizza in a microwave oven followed by crisping the pizza crust with a crisping appliance;
devising a unifying container; and
incorporating the prebaked and frozen pizza and the sequence instructions together in the unifying container.

13. The method of claim 12 wherein the making step includes one of the steps selected from the group consisting of making the pizza a thin crust pizza, making a pizza that weighs about 50 to about 500 grams, making a pizza that weighs about 160 to about 320 grams, making a pizza with a largest dimension that measures in the range of about 6 to about 14 inches, and making a pizza that has a crust periphery without toppings wherein the crust periphery has a width that is about ⅛ inches or greater.

14. The method of claim 12 wherein the devising microwave-crisping sequence instructions includes microwave heating instructions selected from the group consisting of heating the pizza for a time period in the range of 1 minute to about 7 minutes and heating the pizza for a time period in the range of about 90 seconds to 3 minutes.

15. The method of claim 12 wherein the devising microwave-crisping sequence instructions further includes crisping the pizza crust with a crisping appliance selected from the group consisting of a stovetop pan on a stovetop and a toaster oven.

16. The method of claim 15 wherein the crisping step using a stovetop pan on a stovetop further includes crisping for a time period selected from the group consisting of a range of about 30 to about 180 seconds and a range of about 30 to about 90 seconds.

17. The method of claim 12 wherein the making step includes making a handmade pizzeria-type pizza.

18. The method of claim 12 further comprising providing a planar transfer substrate and instructing to use the planar transfer substrate to transfer the prebaked pizza from the microwave oven to the crisping appliance.

19. The method of claim 18 wherein the providing a planar transfer substrate includes providing a grasping adaptation on the transfer device selected from the group consisting of a tab extending co-planar from a peripheral edge, a handle extending above the transfer device, an elongated tab pivotally connected adjacent a peripheral edge of the transfer substrate where the elongated tab pivots between a stored position and a grasping position, and a transverse side extending from a portion of the peripheral edge of the transfer device.

20. The method of claim 18 wherein providing a planar transfer substrate include selecting a planar transfer substrate made from a material consisting of plastic, paper, foil-coated paper, and combinations thereof.

21. A method for rapidly preparing frozen pizza for consumption, the method comprising:
obtaining a frozen pizza preparation package that is a container comprising:
a prebaked frozen pizza having a crust and at least one topping thereon;
a transfer substrate; and
microwave-crisping sequence instructions that instruct placing the prebaked frozen pizza onto the transfer substrate and into a microwave oven, heating the pizza, and using the transfer substrate to transfer the microwave-heated pizza to a crisping appliance, and using the crisping appliance to crisp the crust; and
following the microwave-crisping sequence instructions.
